(19) United States
(12) Patent Application Publication
(10) Pub. No.: US 2024/0230230 A9
(43) Pub. Date: Jul. 11, 2024

(54) FLAME PROTECTION APPARATUS FOR A BURNER, LIFTER PLATE FOR SUCH A FLAME PROTECTION APPARATUS AND DRYING DRUM COMPRISING SUCH A FLAME PROTECTION APPARATUS

(71) Applicant: Benninghoven Zweigniederlassung der Wirtgen Mineral Technologies GmbH, Wittlich (DE)

(72) Inventors: Jörg GENETSCH, Lieser (DE); Matthias Walter JOHANN, Bad Bertrich (DE); Ramón LICHT, Wittlich (DE); Stephan ZIMMER, Morbach (DE)

(21) Appl. No.: 18/489,113

(22) Filed: Oct. 18, 2023

(30) Foreign Application Priority Data
Oct. 20, 2022 (DE) 10 2022 211 109.5

(51) Int. Cl. F26B 25/16; E01C 19/05

(52) U.S. Cl. CPC F26B 25/16; E01C 19/05

(57) ABSTRACT

A flame protection apparatus for a burner, in particular in a drying drum, in particular in an asphalt facility, comprises a central longitudinal axis and a plurality of lifter plates, which are arranged in the circumferential direction with respect to the central longitudinal axis, wherein at least one plate fin holder for holding a plate fin is detachably fastened to each of the lifter plates.

### CROSS-REFERENCES TO RELATED APPLICATIONS

This application claims the priority of German Patent Application, Serial No. DE 10 2022 211 109.5, filed Oct. 20, 2022, the content of which is incorporated herein by reference in its entirety as if fully set forth herein.

### FIELD

The disclosure relates to a flame protection apparatus for a burner, a lifter plate for such a flame protection apparatus and a drying drum comprising such a flame protection apparatus.

### BACKGROUND

DE 10 2017 212 046 A1 discloses an installation for the manufacture of asphalt. A fire tube is arranged in a drying drum to protect the burner flame. In addition, a plate-fin recuperator is arranged in the drying drum as part of a flow guide unit, which is used for the targeted burning of pollutant components in the exhaust gas and/or in by-product gases.

### SUMMARY

It is an object of the disclosure to improve the burning process in a drying drum and, in particular, to carry it out in an uninterrupted manner.

The object is achieved by a flame protection apparatus for a burner, in particular in a drying drum, in particular in an asphalt facility, wherein the flame protection apparatus has a central longitudinal axis and a plurality of lifter plates which are arranged in the circumferential direction with respect to the central longitudinal axis, wherein at least one plate fin holder for holding a plate fin is detachably fastened to each of the lifter plates, by a lifter plate for a flame protection apparatus and by a drying drum comprising a flame protection apparatus.

In a flame protection apparatus, a plurality of lifter plates are arranged in the circumferential direction with respect to a central longitudinal axis of the flame protection apparatus. The lifter plates guarantee an advantageous conveyance of the material to be dried in the drying drum. The flame protection apparatus with the lifter plates is arranged in particular in a region of the drying drum in which a burner flame of the burner is arranged. The lifter plates ensure reliable transport of the material. An undesired contact of the material to be dried with the burner flame is avoided in particular. This can prevent disturbance of the burning process and undesired cooling as a result of disturbance of the flame. The efficiency of the burning process is improved. The emission of undesirable exhaust gases, in particular the proportion of unburned hydrocarbons (C_{ges}), in particular carbon monoxide (CO) and/or carbon dioxide (CO₂) is reduced. The method is ecologically and economically improved. The burning process is more sustainable.

Due to the improved material transport, the flame protection apparatus, in particular the lifter plates, and/or the drying drum are thermally protected from the burner flame and in particular from thermal radiation by the burner flame. The material cools the flame protection apparatus.

The lifter plates are arranged in particular spaced apart from one another in the circumferential direction with respect to the central longitudinal axis. The lifter plates are fastened in particular to an inner wall of the drying drum. The lifter plates are attached to the inner wall of the drying drum by a separate holding element which is directly fastened, in particular welded, to the inner wall of the drying drum.

In particular, the inner wall of the drying drum is partially exposed between two adjacent lifter plates in the circumferential direction. The lifter plates are oriented in particular parallel to the central longitudinal axis.

A further finding is based on the fact that at least one plate fin holder and, in particular, two plate fin holders are detachably fastened to each of the lifter plates. Plate fins as part of the flame protection apparatus can be fastened to the plate fin holders. The plate fins allow an additional improvement of the burning process. By having the plate fin holders, and thus the plate fins, detachably fastened to the lifter plates, retrofitting of the plate fins in the drying drum is simplified. In particular, it has been recognized that the plate fins are wear parts with an average service life of less than one year due to the high thermal load. Due to the detachable fastening, the replacement of the plate fins is simplified. Maintenance times are reduced. The overall efficiency of the facility is increased as a result. The amount of material required to replace worn plate fins is reduced.

The lifter plates are made of a heat-resistant material, in particular a heat-resistant structural steel, which is designated with the material number 1.5415 or with the material abbreviation 16Mo3 according to DIN EN 10028-2. The lifter plates are in particular each designed as sheet metal components and in particular each made from a flat sheet metal blank, in particular by folding. The sheet thickness s of the lifter plate is in particular between 5 mm and 10 mm, in particular between 7 mm and 9 mm and in particular 8 mm.

The plate fin holders are made of a heat-resistant material, in particular an austenitic chromium-nickel steel, in particular with the material number 1.4841 according to DIN EN 10095. This material has a thermal expansion coefficient α of between 15×10⁻⁶ and 20×10⁻⁶, in particular between 17×10⁻⁶ and 18×10⁻⁶, in a relevant temperature range from 300° C. to 700° C. and in particular in a range from 350° C. to 650° C., in particular in a range from 380° C. to 620° C. and in particular in a range from 400° C. to 600° C. Other chromium-nickel steels are also possible, in particular with the material number 1.4828 or 1.4742, which is known under the trade name Sicromal 10.

The flame protection apparatus is used for a burner with which, in particular, an open burner flame is produced. The burner can be operated with fossil fuels, in particular fossil energy sources such as natural gas, liquid gas, fuel oil and/or coal dust. Additionally or alternatively, the burner can be operated with renewable fuels such as wood pellets, wood dust, methane produced from biogas and/or hydrogen gas.

The burner serves in particular to heat a drying drum, which is used in particular to heat material in an asphalt facility. The flame protection apparatus in such a drying drum enables an increased addition of recycled material, i.e. in particular old asphalt granulate. The production of asphalt is thus more sustainable, as the use of raw materials is reduced.

The drying drum ensures uncomplicated and robust installation in the drying drum.

A flame protection apparatus in which the lifter plates are configured in a shovel-like manner ensures improved material transport. The shovel-like lifter plates have an L-shaped contour, in particular in a plane perpendicular to the central longitudinal axis. The lifter plates are arranged on the inner wall of the drying drum in particular such that a material receiving chamber is formed between the lifter plates and the inner wall of the drying drum, which enables reliable material entrainment. In particular, the risk of an undesired material veil forming in the region of the burner flame is reduced. In particular, such a material veil is reliably prevented. The lifter plate is arranged on the inner wall of the drying drum with one web, in particular a short one. This web forms a rear wall of the lifter plate and forms a rear end of the lifter plate with respect to the direction of rotation of the drying drum. Opposite the rear wall, the lifter plate is open. This opening serves in particular to receive and/or discharge material to be dried, which is conveyed along the material conveying direction. The opening extends in particular along the entire width of the lifter plate. This means that the lifter plate is configured without a front wall opposite the rear wall. It is conceivable to design the lifter plate with a front wall which extends at least partially along the width of the lifter plate.

The material receiving channel is designed to be open, in particular along the central longitudinal axis.

A flame protection apparatus in which to each lifter plate at least one fastening bar is attached, which serves to fasten the lifter plate, in particular to an inner wall of the drying drum, enables flexible and reliable fastening of the lifter plates. Fastening bars in particular each have an insertion slot. The insertion slot has a slot width which essentially corresponds to the sheet thickness of the lifter plate. The slot width can be slightly smaller than the sheet thickness of the lifter plate in order to improve fastening by clamping. The lifter plate is held in the fastening bars, in particular in a form-fitting and/or force-fitting manner. The insertion slot extends in particular essentially along the circumferential direction. The lifter plates are each pushed into at least one and in particular into several fastening bars. The fastening bars are in particular fastened to the inner wall of the drying drum such that the insertion slots are arranged in alignment along the central longitudinal axis. The fastening bars allow the lifter plates to be fastened, in particular in a detachable manner, and the pitch angle can be adjusted variably with respect to the inner wall of the drying drum.

A flame protection apparatus in which the at least one plate fin holder is detachably fastened to a rear wall of the lifter plate, wherein the rear wall extends in particular transversely to the inner wall of the drying drum and is arranged in particular in a plane that contains the central longitudinal axis, simplifies a robust fastening of the plate fin holder to the lifter plate. In particular, the plate fin holder can advantageously be stably fastened to a rear wall of the lifter plate by means of a screw connection. The plate fin holder extends in particular in a transverse direction and in particular radially with respect to the central longitudinal axis. This simplifies the radially spaced mounting of the plate fins with respect to the lifter plates.

A flame protection apparatus in which the at least one plate fin holder is attached to the rear wall by means of a holding angled bracket enables the flexible and advantageous orientation of the plate fin holder with respect to the plate fin. In particular, the plate fin holder, which is configured in particular as a flat sheet metal blank, can be oriented transversely and in particular perpendicularly to the central longitudinal axis and can be detachably fastened to the lifter plate in this orientation. A holding angled bracket is in particular configured in an L-shape, in particular as an angled profile with holes for a screw connection.

A flame protection apparatus in which a plurality of lifter plates are arranged one behind the other along the central longitudinal axis, in particular in alignment, enables an uncomplicated formation of a material receiving channel which extends in particular along several lifter plates arranged one behind the other, in particular along the central longitudinal axis. The material receiving channel enables reliable material conveyance along the material conveying direction through the drying drum. The lifter plates are arranged in particular in alignment with each other with respect to the central longitudinal axis.

A lid element which is attached to the end face of a lifter plate prevents an unintentional, in particular frontal, exit of the heated material from the material receiving channel. The material is discharged in particular via the lifter plates to a material outlet from the drying drum. A lid element is attached to the end face of the lifter plate, in particular perpendicular to the central longitudinal axis. The lid element is in particular welded to the lifter plate.

A lifter plate for a flame protection apparatus enables the advantages of the flame protection apparatus itself.

A drying drum comprising a flame protection apparatus enables the burning process to be advantageously performed with increased efficiency and/or reduced exhaust gas emissions. In particular, the drying drum enables the use of increased proportions of old asphalt granulate in asphalt production. The replacement of worn plate fins by means of plate fin holders that are detachably fastened to the lifter plates is simplified.

Both the features set forth above and the features specified in the following embodiment examples of the flame protection apparatus are each suitable, either on their own or in combination with one another, for further embodiment of the subject-matter according to the disclosure. The respective combinations of features do not constitute any restriction with regard to the further embodiments of the subject-matter of the disclosure, but are essentially merely exemplary in character.

Further advantageous embodiments, additional features and details of the disclosure will be apparent from the following description of an embodiment example based on the drawing, in which:

### BRIEF DESCRIPTION OF THE DRAWINGS

FIG. 1 shows a schematic sectional view of an arrangement with a burner attached to a drying drum and a flame protection apparatus arranged in the drying drum,

FIG. 2 shows a longitudinal section through the drying drum according to FIG. 1,

FIG. 3 shows a view of the drying drum according to arrow III in FIG. 1,

FIG. 4 shows an enlarged partial sectional illustration according to section line V-V in FIG. 2,

FIG. 5 shows a perspective view of a front end of the drying drum according to FIG. 2,

FIG. 6 shows an enlarged detail view of detail VI in FIG. 5

FIG. 7 shows a different view of the drying drum according to FIG. 5,

FIG. 8 shows an enlarged detail view of detail VIII in FIG. 7,

FIG. 9 shows a perspective individual view of a plate fin according to FIG. 8.

### DETAILED DESCRIPTION

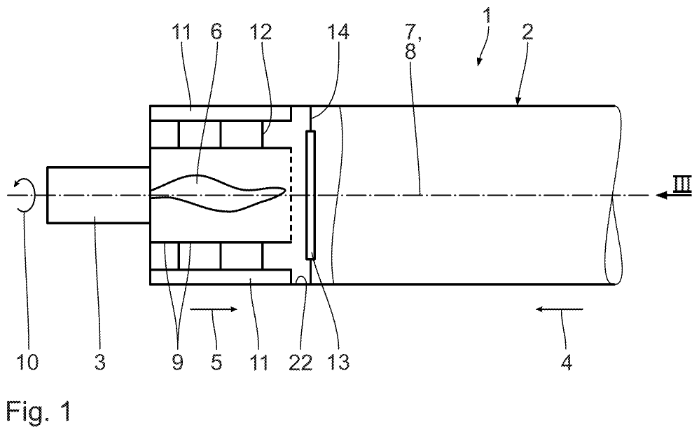

An arrangement designated as a whole as 1 in FIG. 1 comprises a drying drum 2, on the end face of which a burner 3 is arranged. The arrangement 1 is in particular part of an asphalt facility in which asphalt material is produced.

In the drying drum 2, in particular white mineral is heated in a countercurrent process. This means that a material flow direction 4 and a heat propagation direction 5 are oriented opposite to each other. The drying drum 2 can also be operated in a co-current process. In particular, other materials, in particular rock and/or old asphalt material, can also be heated in the drying drum 2.

The burner 3 generates a burner flame 6 which projects at least partially into the drying drum 2.

A flame protection apparatus is arranged in the drying drum 2, in particular in the region of the burner flame 6. The flame protection apparatus has a central longitudinal axis 7 which coincides with an axis of rotation 8 of the drying drum 2.

The flame protection apparatus has a plurality of plate fins 9 arranged in the circumferential direction 10 with respect to the central longitudinal axis 7. The plate fins 9 ensure that thermally heated air remains within the circumferential arrangement 10 and does not unintentionally flow outwards, in particular in a radial direction with respect to the central longitudinal axis 7. The plate fins 9 prevent material heated in the drying drum 2 from unintentionally falling into the burner flame 6 and thus adversely affecting the burning process.

The flame protection apparatus has lifter plates 11. The lifter plates 11 are arranged concentrically with respect to the central longitudinal axis 7, in particular with respect to the plate fins 9 in the drying drum 2. The lifter plates 11 are arranged in the flame region of the drying drum 2. During a rotation of the drying drum 2, the lifter plates 11 enable the material to be dried to be carried along, i.e. material conveyance along the material conveying direction 4. The lifter plates 11 are configured in particular in such a manner that a material veil is prevented in the drying drum 2 when the material is carried along. This means that the material is held in a radial direction in the lifter plates 11 when the drying drum 2 rotates about the axis of rotation 8 and, in particular, material is conveyed exclusively axially along the material conveying direction 4. In particular, by means of the lifter plates 11, it is reliably prevented that the material trickles from top to bottom in the drying drum 2 due to the force of gravity and forms a material veil.

By entraining the material in the lifter plates 11, both the lifter plates 11 themselves and the drying drum 2 are thermally protected from the burner flame 6 and/or the heat radiation emitted by the burner flame 6. As a result, the material cools the fixtures and the drying drum 2.

Plate fin holders 12 are attached to the lifter plates 11 and serve to hold the plate fins 9. The plate fin holders 12 are attached to the lifter plates 11. The plate fin holders 12 extend in particular perpendicularly to the central longitudinal axis 7 and in particular radially.

The flame protection apparatus has a baffle plate 13. The baffle plate 13 is arranged along the central longitudinal axis 7 at an axial distance from the plate fins 9. The baffle plate 13 is disc-like and, in particular, essentially circular in shape and is fastened in the drying drum 2 by at least one baffle plate fastening element 14. The baffle plate 13 prevents the burner flame 6 from unintentionally striking through into a further baffle plate region of the drying drum 2 that is arranged behind the baffle plate 13. A material veil is deliberately produced in this additional baffle plate region. The baffle plate 13 prevents damage to the material.

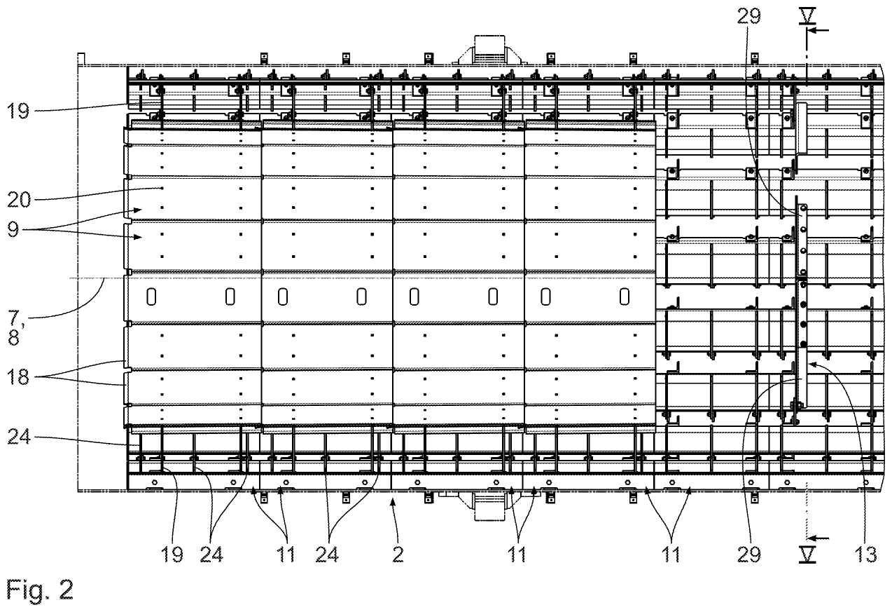

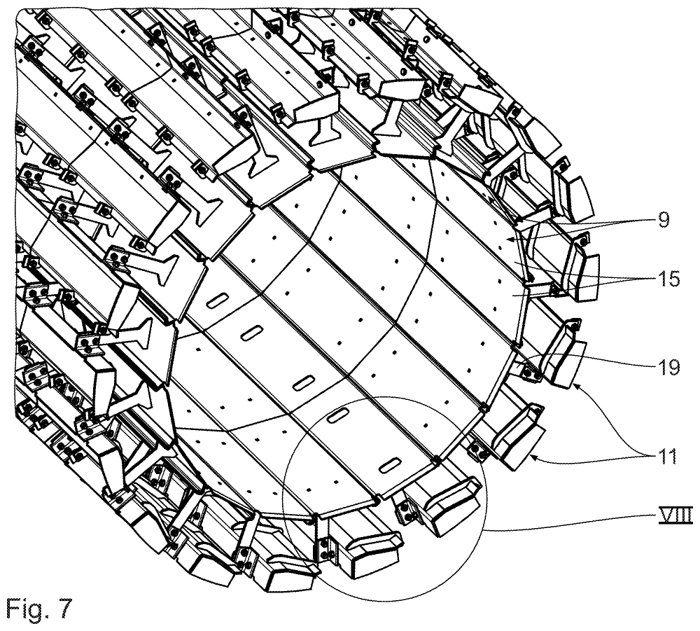

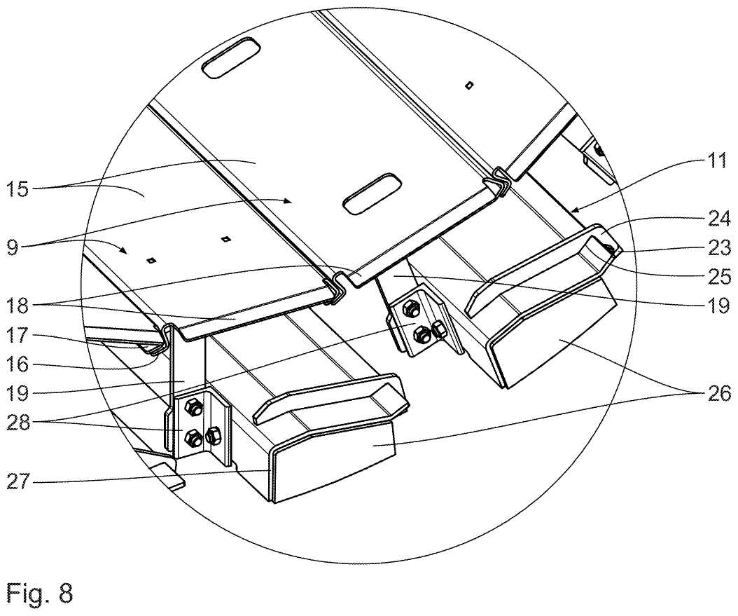

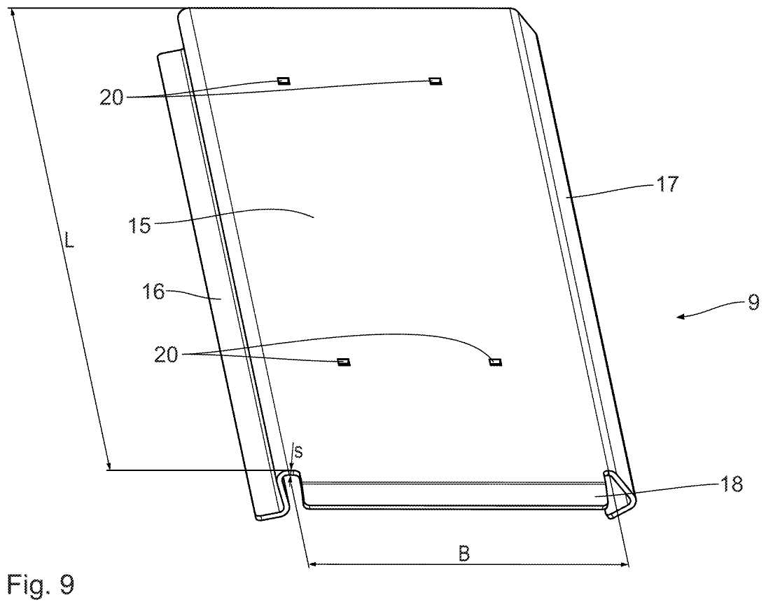

The flame protection apparatus is explained in more detail below with reference to FIG. 2 to FIG. 9.

A circumferential arrangement of the plate fins 9 comprises eighteen individual plate fins 9. The plate fins 9 are configured to be functionally identical and in particular have identical dimensions. Depending on the size to be formed, i.e. the clear width of the circumferential arrangement, more or less than eighteen plate fins 9 may also be used to form a circumferential arrangement.

Along the central longitudinal axis 7, four circumferential arrangements are arranged one behind the other according to the embodiment example shown. More or less than four circumferential arrangements may also be arranged one behind the other. The individual circumferential arrangements are in particular of identical design. It is also conceivable that the circumferential arrangements have different diameters and/or are configured conically at least in sections.

The plate fins 9 each have a flame protection section 15 facing inwards, i.e. towards the burner flame 6. The flame protection section 15 has a rectangular contour with a length L and a width B. According to the embodiment example shown, the length L of the plate fin 9 is greater than its width B. In particular, L>=1.2×B, in particular L>=1.5×B, in particular L>=2.0×B, in particular L>=2.5×B and in particular L<=10×B. The plate fins 9 are arranged side by side in the circumferential arrangement with respect to their longitudinal direction. In the circumferential arrangement, the plate fins 9 are oriented with their longitudinal direction parallel to the central longitudinal axis 7. This means that a contour formed by the plate fins 9 in a plane perpendicular to the central longitudinal axis 7 is constant along the central longitudinal axis 7. Due to the fact that the flame protection sections 15 are designed to be flat, the circumferential arrangement has an inner contour in a plane perpendicular to the central longitudinal axis 7, which inner contour is essentially polygonal in shape.

The plate fins 9 are made from the material with the number 1.4841 from a sheet metal blank. The sheet thickness s is in particular in a range of 3 mm to 10 mm and in particular between 5 mm and 7 mm.

The plate fin 9 has sealing elements 16, 17 that are formed in one piece on its longitudinal edges. The sealing elements 16, 17 are configured as folded edges. The sealing elements 16, 17 are configured to correspond to each other. The sealing elements 16, 17 form lateral sealing elements on the plate fins 9. The sealing elements 16, 17 form sealing strips. The sealing elements 16, 17 are designed so that the plate fins 9 are arranged alternately with the sealing elements 16, 17 in the circumferential order.

A first sealing element 16 has essentially an S contour. The S-contour extends in particular from the flame protection section 15 in a direction facing away from the burner flame 6. The first sealing element 16 forms a concave receptacle.

The second sealing element 17 has a contour which corresponds to a rounded arrowhead. The second sealing element 17 forms a convexly shaped projection.

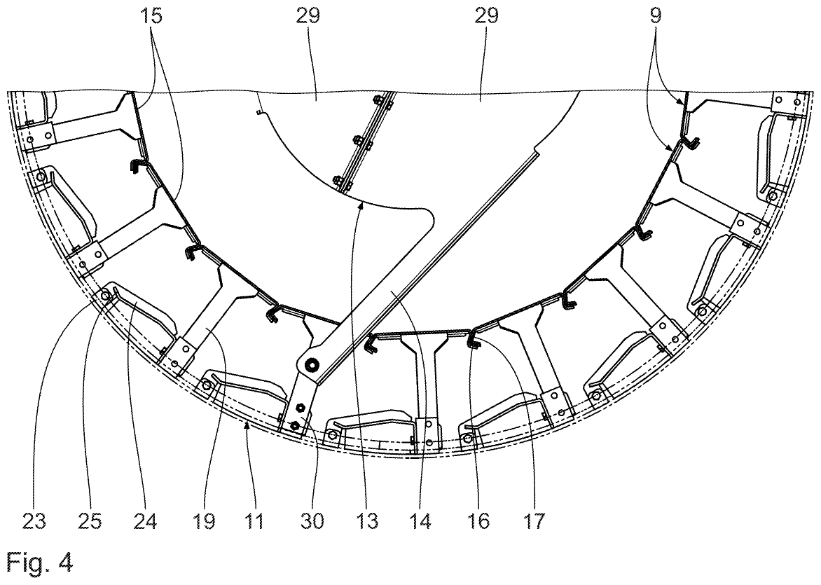

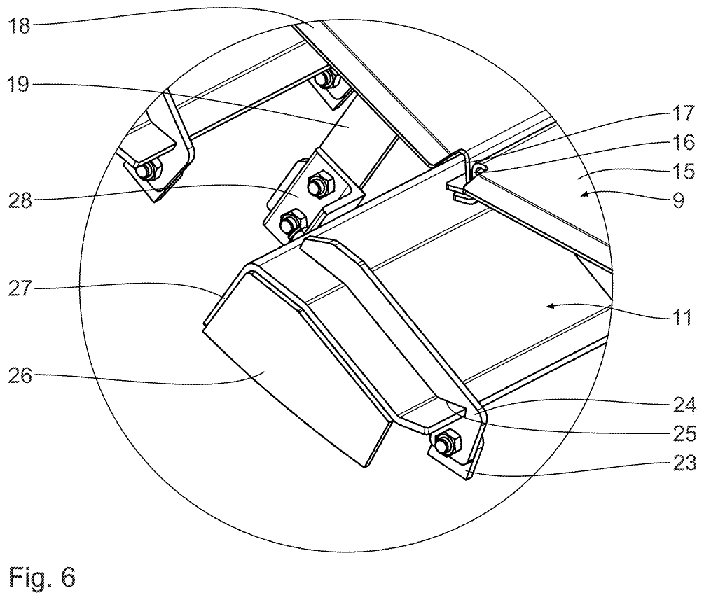

The convex outer contour of the second sealing element 17 corresponds to the concave inner contour of the first sealing element 16. In particular, the second sealing element 17 of a plate fin 9 can be arranged at the first sealing element 16 of an adjacent plate fin 9. This arrangement of adjacent plate fins 9 with the sealing elements 16, 17 arranged one inside the other is shown in particular in FIGS. 4 and 6. Corresponding sealing elements 16, 17 of adjacent plate fins 9 interlock with each other so that at most a thin air gap remains which is at any rate smaller than the sheet thickness s of the plate fins 9. In particular, the maximum gap width is at most 0.5×s, in particular at most 0.3×s, in particular at most 0.2×s and in particular 0.1×s.

Due to this thin gap between the adjacent plate fins 9, a circumferential gap seal is formed. As a result of the thermal expansion of the plate fins 9 during the operation of the drying drum 2, the gap width continues to decrease.

Due to the fact that the plate fins 9 of a circumferential arrangement interlock with the respective adjacent sealing elements 16, 17, the circumferential arrangement is configured to be self-supporting. It is prevented that the plate fins 9 detach from each other unintentionally. The sealing elements 16, 17 engage behind the adjacent plate fins 9 such that the circumferential arrangement is stable in the radial direction with respect to the central longitudinal axis 7.

At a transverse edge which is oriented in the width direction, the plate fins 9 have a front folded edge 18. The front folded edge 18 is inclined downwards by an angle of inclination with respect to the plane formed by the flame protection section 15. This angle of inclination is at most 30°, in particular at most 20°, in particular at most 15° and in particular at most 10°. The folded edge 18 acts as an insertion tab which can be inserted in particular into the respective circumferential arrangement that is arranged upstream thereof.

If multiple circumferential arrangements are arranged one behind the other along the central longitudinal axis 7, the plate fins 9 of the respective rear circumferential arrangement are pushed with the folded edge 18 under the respective plate fin 9 of the circumferential arrangement arranged upstream. This means that the folded edge 18 is arranged on the inside of the circumferential arrangement facing the burner flame 6. The folded edge 18 forms an axial gap seal between the circumferential arrangements that are arranged one behind the other along the central longitudinal axis 7. The tightness of the circumferential arrangements is high.

The plate fins 9 arranged one behind the other along the central longitudinal axis 7 are arranged in alignment.

Each plate fin 9 is held by at least one plate fin holder 19 and, according to the embodiment example shown, by two plate fin holders 19. The plate fin holder 19 is made from a flat sheet metal blank and in particular has a strip-like contour. The plate fin holder 19 is in particular made of the same material as the plate fin 9. The sheet thickness of the plate fin holder is in particular between 8 mm and 15 mm and in particular between 10 mm and 12 mm.

According to the embodiment example shown, the plate fin holder 19 has projections, in particular two holding pins, which are arranged in particular on the front side. The holding pins can engage in recesses 20 which are arranged at the flame protection section 15. The recesses 20 are in particular configured as punched holes. The plate fin 9 is in particular supported or placed on the plate fin holder 19. The recesses 20 serve as a mounting aid for the plate fin holder 19 of the plate fin 9. In particular, the plate fin 9 is detachably fastened to the plate fin holder 19. This simplifies the assembly of the circumferential arrangement. In addition or alternatively, the plate fin holders 19 can also be non-detachably fastened to the plate fin 9, in particular welded on.

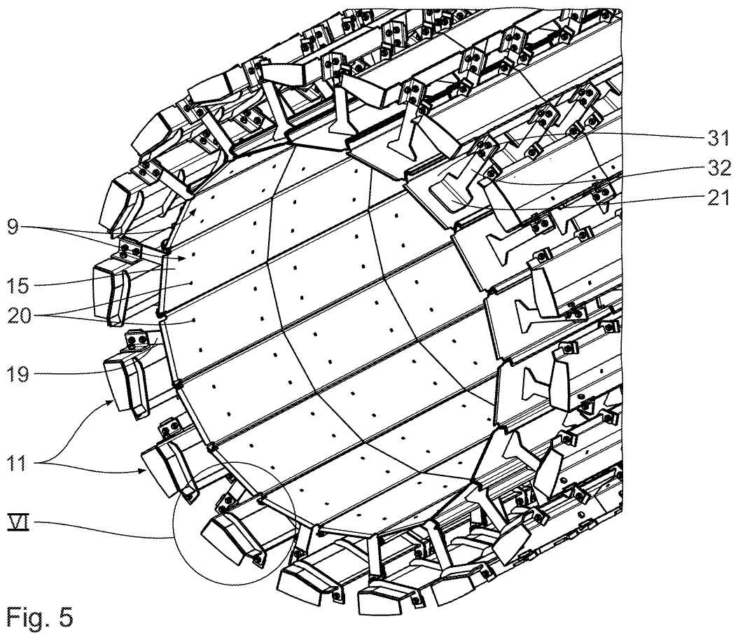

In each case, at least one plate fin 31 per circumferential arrangement is designed differently with respect to the recesses 20. This plate fin is referred to as the end plate fin 31. Accordingly, the associated end plate fin holders 32 for the end plate fin 31 do not have any protruding holding pins, but rather a bent-over supporting tab 21, which is shown in particular in FIG. 5.

The circumferential arrangement is formed by arranging plate fins 9 adjacent to one another in sequence in the circumferential direction 10 and placing them on the respective plate fin holders 19. The plate fins 19 are stabilized by the interlocking sealing elements 16, 17 on the one hand and by the engagement of the holding pins in the recesses 20 on the other hand. The last plate fin 31 is inserted axially, i.e. in a direction parallel to the central longitudinal axis 7, and engages with the two adjacent plate fins 9. The sealing elements 16, 17 ensure an undercut in the radial direction between adjacent plate fins 9 or 9, 31. The last mounted plate fin 31 is fastened, in particular welded, to the supporting tabs 21.

By using the plate fin holders 19, it is possible for the plate fins 9 to be arranged in the drying drum 2 at a radial distance with respect to an inner wall 22 of the drying drum 2. The plate fins 9 form an installation that is spaced from the inner wall 22 and aligned concentrically with respect to the central longitudinal axis 7. The circumferential arrangement is substantially ring-shaped with the polygonal inner contour. The circumferential arrangement is fixedly connected to the drying drum 2. When the drying drum 2 rotates, the circumferential arrangement rotates with it.

With respect to the plate fins 9, the lifter plates 11 are arranged so as to be offset radially outwards with respect to the axis of rotation 8. In particular, the lifter plates 11 are arranged on the inner wall 22 of the drying drum 2.

For this purpose, holding tabs 23 can be fastened directly to the inner wall 22, in particular welded thereto. A fastening bar 24 is detachably fastened, in particular screwed, to each of the holding tabs 23. In particular, each lifter plate 11 is held by several, in particular three, fastening bars 24, wherein the fastening bars 24 are configured to be identical and are arranged at a distance from one another along the central longitudinal axis 7.

The fastening bars 24 each have a slot-shaped receptacle 25 into which the lifter plates 11 are inserted.

The lifter plate 11 is designed to be shovel-like and has an L-shaped contour in a plane that is oriented perpendicularly with respect to the central longitudinal axis 7. The lifter plate 11 is arranged on the inner wall 22 of the drying drum 2 such that the short web of the “L” extends essentially parallel to the inner wall 22 of the drying drum 2. Essentially means that the lifter plate 11 has no curvature on the inner wall 22 of the drying drum 2. To increase stiffness, the lifter plate 11 can be designed with folded edges. A material receiving chamber is formed between the lifter plate 11 and the inner wall 22 of the drying drum 2, which has an open rectangular contour in a plane perpendicular to the central longitudinal axis 7. The rectangle is open on a side opposite the short web of the “L”. In particular, the material receiving chamber is also open along the central longitudinal axis 7. It is possible that these end faces of the material receiving chamber are closed by separate lid elements 26. In particular, the end face of the material receiving chamber that faces the material outlet of the drying drum 2 is closed by the lid element 26. The lid element 26 is fastened, in particular welded, to the lifter plate 11.

The lifter plates 11 arranged one behind the other along the central longitudinal axis 7 are thus arranged continuously relative to one another, i.e. abutting one another at the end faces. The material receiving channel that extends over several lifter plates 11 is formed by the lifter plates 11.

The design of the lifter plates 11 ensures that the material to be heated is reliably carried along in the drying drum 2, but that no material veil is formed in the region of the plates 9.

The short web of the “L” forms a rear wall 27 of the lifter plate 11. The plate fin holders 19 of the plate fins 9 are detachably fastened to the rear wall 27. According to the embodiment example shown, a holding angled bracket 28 in particular serves for this purpose, which bracket 28 is designed in particular as an L-profile and enables the sheet metal sections that are oriented at 90° to each other to be screwed together.

It is particularly advantageous that the plate fin holders 19 are detachably fastened to the lifter plates 11. Retrofitting the plate fin holders 19 and/or the plate fins 9 held thereon is simplified. In particular, it is not necessary for the plate fins 9 to be fastened to the inner wall itself by means of the plate fin holders 19. The mounting effort and dismounting effort are reduced.

In particular, at least one lifter plate 11 is provided for each plate fin 9. Corresponding plate fins 9 and lifter plates 11 are arranged in alignment in the radial direction with respect to the central longitudinal axis 7.

According to the embodiment example shown, in addition to the four lifter plate arrangements, which are arranged concentrically to the respective circumferential arrangements of the plate fins 9, two further rows of lifter plates 11 are provided. No plate fins 9 are fastened to these lifter plates 11. These lifter plates are thus arranged in an exposed position.

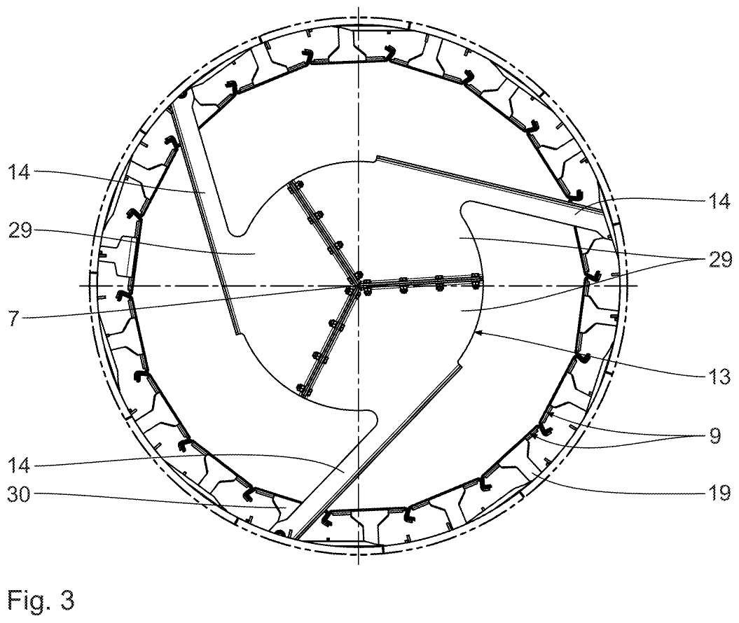

Axially spaced from the plate fins 9 there is the baffle plate 13, which is shown in particular in FIG. 3. The baffle plate 13 is configured from several, according to the embodiment example shown three, identical baffle plate segments 29. The baffle plate segments 29 each have a disc section and a baffle plate fastening element 14 that is attached thereto in one piece. The disc sections are each configured according to a one-third circular disc, i.e. with an opening angle of 120° with respect to the central longitudinal axis 7. To connect the baffle plate segments 29, flange strips are folded on the baffle plate segments 29 and screwed together. The baffle plate segments 29 are attached to corresponding lifter plates 11 by means of the baffle plate fastening elements 14 and a holding tab 30 provided for this purpose.

What is claimed is:

1. A flame protection apparatus for a burner, the flame protection apparatus comprising:
a plurality of lifter plates arranged in the circumferential direction with respect to a central longitudinal axis, wherein at least one plate fin holder for holding a plate fin is detachably fastened to each lifter plate of the plurality of lifter plates.

2. The flame protection apparatus according to claim 1, wherein the flame protection apparatus is in a drying drum.

3. The flame protection apparatus according to claim 2, wherein the drying drum is part of an asphalt facility.

4. The flame protection apparatus according to claim 1, wherein the lifter plates are configured in a shovel-like manner.

5. The flame protection apparatus according to claim 1, wherein to each lifter plate of the plurality of lifter plates at least one fastening bar is attached.

6. The flame protection apparatus according to claim 5, wherein the at least one fastening bar is configured to fasten the lifter plate to an inner wall of the drying drum.

7. The flame protection apparatus according claim 1, wherein the at least one plate fin holder is detachably fastened to a rear wall of the each lifter plate.

8. The flame protection apparatus according to claim 7, wherein the rear wall extends transversely to the inner wall of the drying drum.

9. The flame protection apparatus according to claim 7, wherein the rear wall is arranged in a plane that contains the central longitudinal axis.

10. The flame protection apparatus according to claim 7, wherein the at least one plate fin holder is attached to the rear wall by means of a holding angled bracket.

11. The flame protection apparatus according to claim 1, wherein at least some lifter plates of the plurality of lifter plates are arranged one behind the other along the central longitudinal axis.

12. The flame protection apparatus according to claim 11, wherein the at least some lifter plates are arranged in alignment.

13. The flame protection apparatus according to claim 1, wherein a lid element is attached to the end face of at least one lifter plate of the plurality of lifter plates.

14. A lifter plate for a flame protection apparatus according to claim 1.

15. A drying drum comprising a flame protection apparatus according to claim 1.
